(19) United States
(12) Patent Application Publication
(10) Pub. No.: US 2018/0056135 A1
(43) Pub. Date: Mar. 1, 2018

(54) Angler QuickDraw Carabiner with Deflection Fin

(71) Applicant: Young Chu, Fullerton, CA (US)

(72) Inventor: Young Chu, Fullerton, CA (US)

(21) Appl. No.: 15/330,196

(22) Filed: Aug. 23, 2016

(51) Int. Cl. A63B 29/02; F16B 45/02

(52) U.S. Cl. CPC A63B 29/02; F16B 45/02

(57) ABSTRACT

This invention is a safety carbiner intended to allow a climber to move around in all positions on the climbing surface without fear that the rope will exert pressure on the gate and accidentally open the gate and allow the rope to escape. The Deflection Fin on the outside of the nose of the long arm of the carbine forces the rope away from the gate.

ANGLER QUICKDRAW CARABINER with DEFLECTION FIN uses a keylock gate on the bolt side for easy clipping and a deep basket on the nose that assures easy clipping by the climber with the Deflection Fin designed to prevent un-clipping by deflecting the rope away from the nose of the carabiner.

### CROSS-REFERENCE TO RELATED APPLICATIONS

There are no previous applications to reference in this present application.

### STATEMENT AS TO RIGHTS TO INVENTIONS MADE UNDER FEDERALLY SPONSORED RESEARCH AND DEVELOPMENT

Not applicable

### REFERENCE TO A “SEQUENCE LISTING,” A TABLE, OR A COMPUTER PROGRAM LISTING APPENDIX SUBMITTED ON A COMPUTER DISK

Not applicable

### BACKGROUND OF THE INVENTION AND PRIOR ART

This invention relates to mechanical coupling mechanisms used in rock climbing or mountaineering where there is a strong focus on safety, strength and weight of the equipment, this invention relates to an improved carabiner system by adding a Deflection Fin to the nose of the carabiner to prevent unclipping by the rope during use of carabiner. The Deflection Fin provides the safety function of deflecting the rope away from the nose and gate of the carabiner to prevent accidental un-clipping of the rope as the rope moves over the nose and gate during the traverse of an inclined surface.

The following references provide supplemental and background information for this invention.

1. Climbing Dictionary & Glossary—(http:www.mountaindays.net/content/articles/dictionary.php#karabiner).

2. Carabiners used for fall protection in US industry are classified as “connectors” and are required to meet Occupational Safety and Health Administration standard 1910.66 App C Personnel Fall Arrest System which specifies “drop forged, pressed or formed steel, or made of equivalent materials” and a minimum breaking strength (MBS) of 5,000 lbf.

3. ANSI/American Society of Safety Engineers standard ANSI Z359.1 1-2007 Safety Requirement for Personnel Fall arrest Systems, section 3.2.1.4 for snap hooks and carabiners requires that all connectors/carabiners support a (MBS) of 5,000 lbf and feature an auto-locking gate mechanism which supports a MBS of 3,600 lbf.

4. Minimum breaking strength requirements and calculations for rescue carabiners are set out in National Fire Protection Association standard 1983 Fire Service Life Safety Rope and Equipment.

### SUMMARY OF INVENTION

According to the invention, a carabiner or a mountaineering carabiner or a safety carabiner is a mechanical device used to link rope, slings, other climbing aids together to allow a climber of any inclined surface to remain anchored for safety to the surface while moving up, down or laterally across the surface. In the event of a fall the climber will be caught by the safety rope as it becomes taught and pulls against the anchor.

A carabiner is a snap-hook used to attach a climber's body harness to the climbing safety rope which connects the anchor. Carabiners often come in pairs referred to as quickdraws—a quickdraw is two carabiners attached together via a nylon sling. One end of the quickdraw is clipped into the anchor; the other is clipped into the climber's safety rope. Most mountaineering carabiners are palm sized, “D” shaped rings of a lightweight, high strength material, usually a heat-treated aluminum alloy.

The “D” shaped ring has a gate or lock that is spring loaded for insertion of climbing aids and a frame; consisting of a long arm that includes a nose for locking the gate when closed, a spine that connects to the short arm, a short arm that bends around to create a rope pocket and ends to form the base for the spring loaded gate. The gate is spring loaded to remain closed until depressed to open and allow the insertion of climbing aids such as ropes or anchors.

The spring loaded gate is designed to remain closed unless pushed open by the climber for the insertion of climbing aids. Once a climbing rope is inserted into the carabiner the optimum configuration is for the rope to rest on the short arm and exert pressure on the longitudinal axis when the rope moves around inside the carabiner. When the movement of the rope is such that that the carabiner is in the vertical axis the climbing rope will often enter the carabiner pressing against the short arm and exit pressing against the long arm. When the carabiner returns to a horizontal axis the rope at top of carabiner often must move across the long arm to return to the short arm position of optimal use.

As the rope moves across the nose of the carabiner it can exert pressure on the gate and press the gate open resulting in both ends of the rope being inside the carabiner and slipping totally out when pressure is applied. The present invention, Deflection Fin, attached outside of the nose of the long arm of the carabiner forces the climbing rope away for the gate so the rope can safely remain on the outside of the carabiner. On the outside of the carabiner the rope can absorb the pressure inside the short arm of the carabiner to hold the climber in the event of a fall.

### DRAWINGS

FIG. 1 is a depiction of a Standard Carabiner. (1A) pictures the bare carabiner. (1B) pictures the wire gate only. (1C) pictures the carabiner with wire gate installed in closed position. (1D) pictures the carabiner with wire gate installed in the open position.

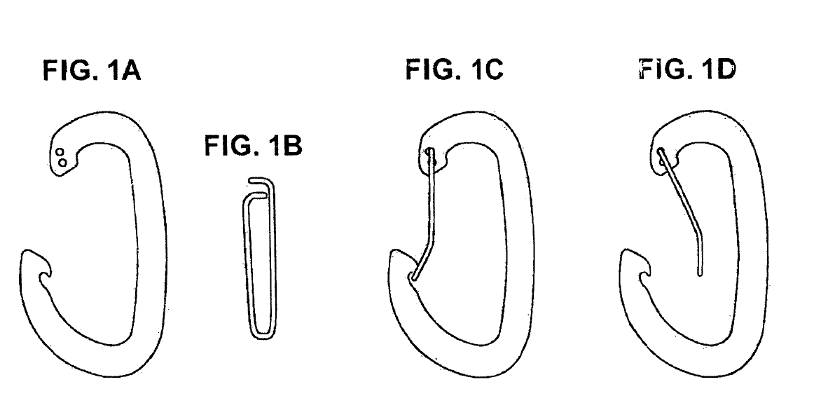

FIG. 2 is a depiction of a carabiner being attached to an anchor or hanger, (2A) pictures a typical hanger or anchor. (2B) pictures the carabiner being attached to the hanger by insertion of the nose. (2C) pictures the carabiner attached to hanger and hanging by the long arm of the carabiner. (2D) pictures the carabiner in the “use” position attached to the hanger by the short arm of the carabiner.

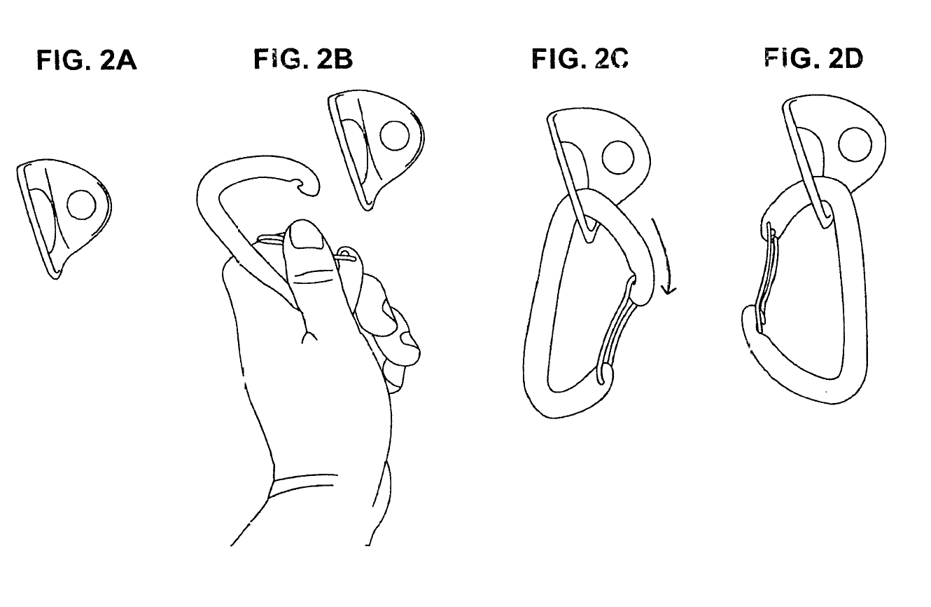

FIG. 3 is a depiction of a Standard Carabiner attached to an anchor or hanger. (3A) pictures standard carabiner attached to anchor or hanger with climbing rope fully engaged inside the carabiner. (3B) pictures the rope sliding over the nose of the carabiner as the rope moves around the carabiner during use. (3C) pictures the rope hitting and opening the wire gate which allows both ends of rope to be inside the carabiner. (3D) pictures the rope fully separating from the carabiner when pressure is applied during movement or a fall of a climber.

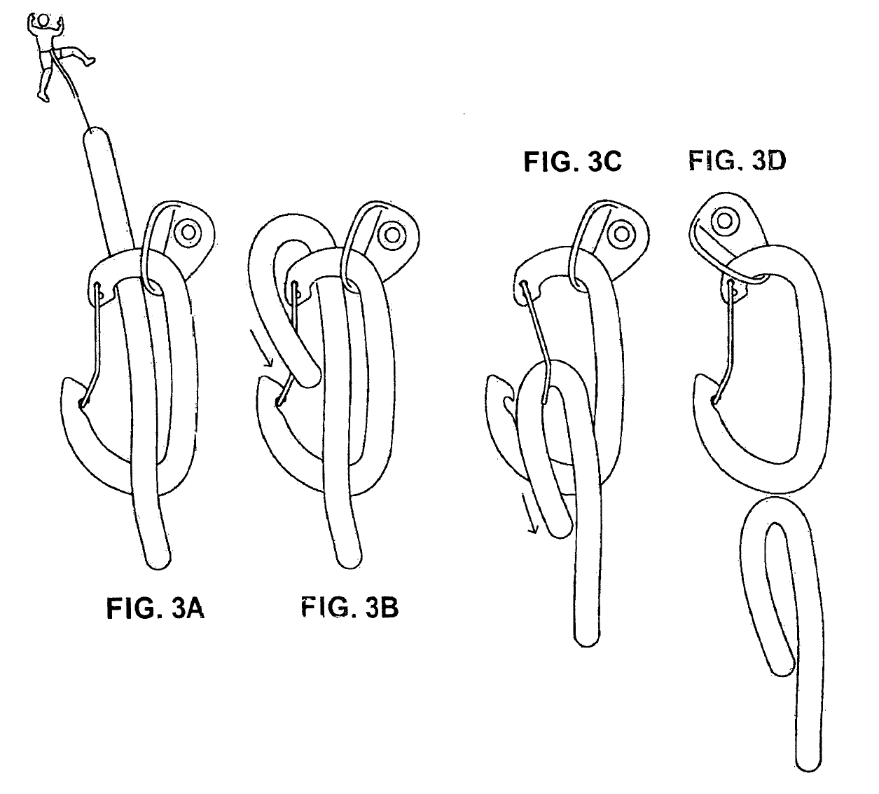

FIG. 4 is a depiction of the Deflection Fin Carabiner as manufactured. (4A) pictures the carabiner with Deflection Fin installed on the end of the short arm of the carabiner near the fastening point of the spring loaded gate. (4B) pictures the wire gate of the carabiner. (4C) pictures a plane view of the carabiner with deflector fin attached. (4D) pictures Deflection Fin Carabiner with closed gate. (4E) pictures Deflection Fin Carabiner with open gate.

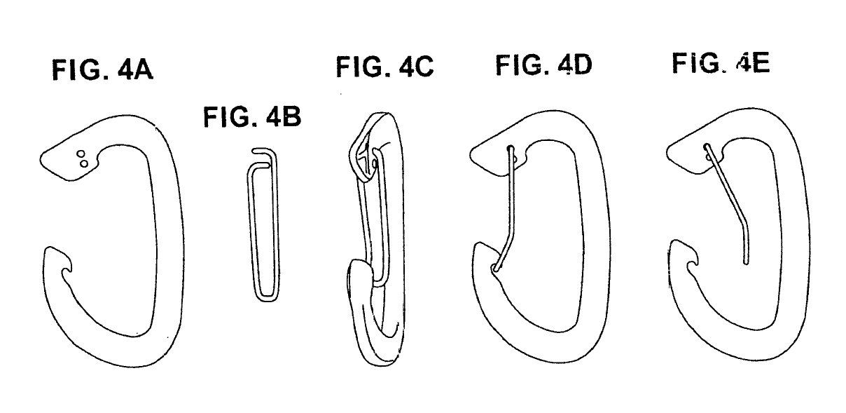

FIG. 5 is a depiction of the Deflection Fin Carabiner in use on a climb. (5A) pictures deflection fin carabiner attached to anchor or hanger with climbers rope installed. (5B) pictures climber's rope in use moving around deflector fin carabiner. (5C) pictures climber's rope in use moving over the nose of deflection fin carabiner and being forced outside the gate to move harmlessly over the carabiner. (5D) pictures the climber's rope safely inside the carabiner prepared for any exertion of pressure from use or an emergency fall by climber.

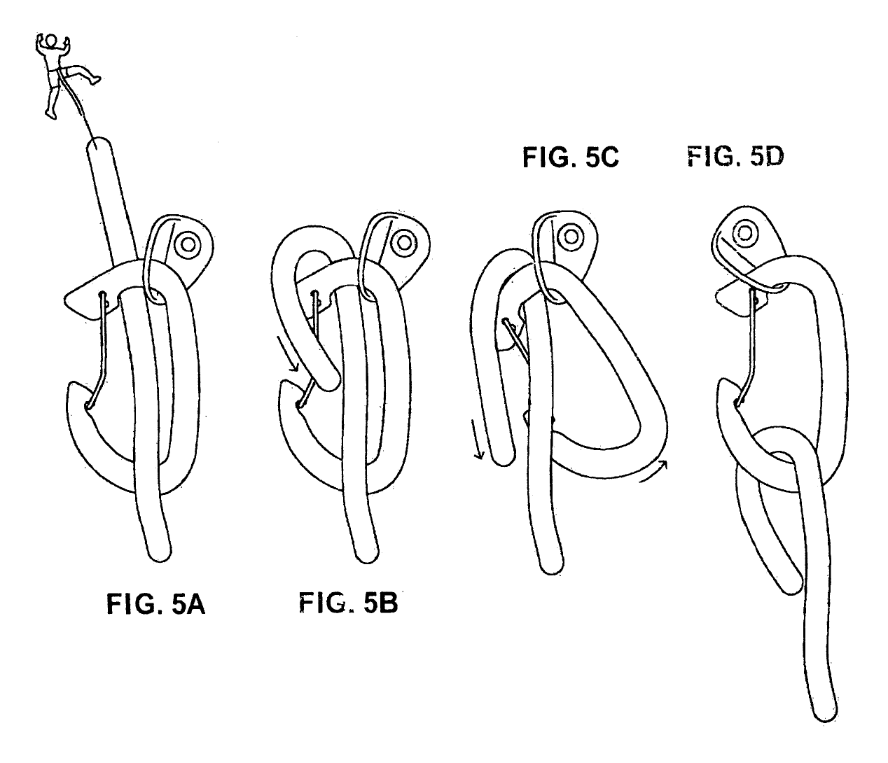

The drawings are an integral part of the system in this invention and by this reference are incorporated herein as though set forth in full.

1. The system in this invention comprising a Deflection Fin Carabiner has a frame partially enclosing an inner region having a long arm; a spine; a short arm and a gate pivotally coupled to the frame, spring loaded to close the gate against the nose of the long arm: thereby resulting in a closed configuration of the entire frame. Any embodiments arising out of the claims set out in this application are by reference made a part of this invention.
The system in this invention provides a Deflection Fin molded onto the nose of the long arm of the carabiner frame.
The system in this invention further provides the Deflection Fin to deflect the rope away from the nose/gate of the carabiner.
The system in this invention provides the Angler Quickdraw with Deflection Fin which uses a keylock gate on the bolt side for easy clipping on the rope or an anchor/hanger. With a deep basket on the nose where the rope clips in, the unique Angler design on the rope-end allows the climber to make quick and secure clips with the Deflection Fin preventing un-clipping by deflecting the rope away from the nose/gate of the carabiner.
The system in this invention comprises the Deflection Fin which reduces the risk of injury or death caused by the un-clipping of the rope from the Quickdraw during a “lead” fall by deflecting the rope away from the nose/gate of the carabiner.
As a further embodiment the Quickdraw Carabiner includes at least an interstitial region, (4E), for receiving a portion of the user's finger/s so as to facilitate the opening of the gate.
As a further embodiment the Quickdraw Carabiner includes in the interstitial region a through region, (4E).
As a further embodiment the Quickdraw Carabiner is characterized in that the frame is “D” shaped wider on the long arm portion of carabiner.
As a further embodiment the Quickdraw Carabiner gate is a wire gate or a solid gate.
As a further embodiment the Quickdraw Carabiner claims all of the claims and embodiments set forth in this application in the use of the Quickdraw Carabiner with Deflection Fin in climbing, in building, in industry and in shipping and navigation.
